(19) United States
(12) Patent Application Publication
(10) Pub. No.: US 2003/0232553 A1
(43) Pub. Date: Dec. 18, 2003

(54) Nonwoven material and method for its production

(75) Inventor: Mikael Strandqvist, Lindome (SE)

Correspondence Address: YOUNG & THOMPSON, 745 SOUTH 23RD STREET 2ND FLOOR, ARLINGTON, VA, 22202

(73) Assignee: SCA HYGIENE PRODUCTS AB, GOTEBORG (SE)

(21) Appl. No.: 10/438,014

(22) Filed: May 15, 2003

Related U.S. Application Data
(60) Provisional application No. 60/387,899, filed on Jun. 13, 2002.

(51) Int. Cl. B32B 3/00; B32B 5/02; B32B 9/00; D04H 1/00; B05D 1/02

(52) U.S. Cl. 442/59; 442/408; 442/153; 442/148; 427/421

(57) ABSTRACT

A method of producing a nonwoven material including cellulose fibres and synthetic fibres, wherein the fibres are formed into a web which is hydroentangled, and a lint-preventing agent is added to the fibre web through at least one spray nozzle in a step subsequent to the hydroentanglement. The produced nonwoven material is in the form of a fibre web or fibre fabric and includes a lint-preventing agent. The fibre web or fibre fabric exhibits an internal region and a first and a second external region located on both sides of the internal region, wherein at least the first external region contains more lint-preventing agent than the internal region.

### CROSS REFERENCE TO RELATED APPLICATION

This application claims the benefit of U.S. Provisional Application No. 60/387,899 filed on Jun. 13, 2002.

### FIELD OF THE INVENTION

The present invention relates to a method of producing a nonwoven material including cellulose fibres and synthetic fibres, according to which method the fibres are formed into a web which is hydroentangled. The invention also relates to a nonwoven material in the form of a fibre web or fibre fabric including a lint-preventing agent, which fibre web or fibre fabric exhibits an internal region and a first and a second external region located on both sides of the internal region.

### BACKGROUND OF THE INVENTION

There are many fields of applications for nonwoven materials. Amongst other things, they are utilised in wiping cloths. Such wipes can be utilised for different purposes, for example within infant care, for make-up removal, or for cleaning different objects. The components included in the nonwoven material and the way of treating them are chosen in accordance with the intended field of use. Wipes are manufactured both in dry and wet designs, wherein the wet wipes primarily are utilised in the absence of water, or when the added liquid is better adapted to its purpose than water.

Wet strength is an important parameter for wipes within most fields of uses. Thereby, “wet strength” refers to the ability of the material to maintain its integrity and function in a wet condition. A conventional way of increasing the wet strength of a nonwoven material is to add a wet strength agent to the material.

Another important parameter for wipes is low linting or low release of fibres, i.e. that the wipe does not release fibres onto the object which is wiped.

EP 602 881 describes a method of producing a nonwoven material. In a first step, a fibre dispersion comprising water, fibres, and a wet strength agent is prepared. Subsequently, the fibres are formed into a web in a forming step. A hydroentanglement step succeeds to the forming step.

Even if a more wet-strong material will be obtained by means of such a method, the method is associated with certain problems. One problem associated with the conventional method of adding the wet strength agent to the fibre dispersion is that the wet strength agent, as time goes on, causes clogging of the filters which are arranged in the hydroentanglement step. In that case, the production will have to be stopped for cleaning of the filters. Recently, this problem has been accentuated since it has become more common with closed hydroentanglement systems. The wet strength agent influences the hydroentanglement water and causes more and more frequent clogging of the filters and, as a consequence, stops in the production process.

### SUMMARY OF THE INVENTION

Accordingly, it is problematic to obtain wet-strong, hydroentangled nonwoven materials which exhibit a low fibre linting, while simultaneously avoiding clogging of the filters in the entanglement step.

By means of the invention, the above-mentioned problems are solved by adding a lint-preventing agent to the fibre web through at least one spray nozzle in a step subsequent to the hydroentanglement.

According to the invention, “lint-preventing agent” refers to an agent which prevents linting of the nonwoven material, i.e. fibre linting from the material surface. Fibres which are released from the nonwoven material surface during use will primarily end up on the object which is wiped, something which is highly undesirable in many applications. One way of avoiding this is to attach the fibres more firmly to the surface of a nonwoven material. This can be done in many different ways. One way of accomplishing this is to add a substance which forms a fibre network with itself around the fibres. This fibre network prevents fibre linting. Another way is to add a substance which is capable of reacting with functional groups on the fibres and to form bonds between the fibres in this way. Examples of substances capable of functioning in the above-mentioned fashion are e.g. polymers having reactive groups. According to one embodiment of the invention, the lint-preventing agent is poly(amido-amine)-epichlorohydrin (PAE). Other examples are glyoxylated polyacrylic amide (GPAM) and carboxymethyl cellulose (CMC).

According to one embodiment of the invention, the synthetic fibres are extruded into a web in one step, and the cellulose fibres are wetlaid onto this web in a step preceding the entanglement step. According to an alternative embodiment, the synthetic fibres in the form of staple fibres and the cellulose fibres are wetlaid in a step preceding the entanglement step.

The extrusion method can be carried out, for example, by means of a meltblowing or spunbonding technique. According to the spunbonding technique, a polymer melt is extruded through a spinneret and forms discrete filaments. Subsequently, the filaments are stretched out in a mechanic or pneumatic way so that they form a fibre web of continuous filaments. According to the meltblowing technique, a polymer melt is extruded through a nozzle. When the polymer melt discharges from the nozzle, it is stretched out into thin, discontinuous filaments by means of a high pressure fluid, such as hot air or vapour.

One example of cellulose fibres is pulp fibres, i.e. fibres manufactured by means of a pulping process. The pulp fibres can be chemical, mechanical, thermo-mechanical, chemi-mechanical or chemi-thermomechanical pulp (CTMP). They can also be recycled fibres or so-called curled fibres, cellulose fibres which have been modified by means of citric acid. Another example of cellulose fibres is cotton linters.

Examples of synthetic fibres are fibres of regenerated cellulose such as lyocell, rayon and viscose, and fibres made of hydrocarbons. Examples of the latter fibre type are fibres made of polyolefins such as polypropylene and polyethylene, polyesters such as polyethylene terephtalate and polybutylene terephtalate, polyamides such as nylon 6 and nylon 6,6, polylactic acid and polylactide. Furthermore, the synthetic fibres can be bi-component fibres.

In order to obtain a uniform distribution of the lint-preventing agent across the fibre web, according to a preferred embodiment, the agent is mixed with water before it is sprayed across the fibre web. According to an alternative embodiment, the lint-preventing agent is mixed with air and atomized before it is sprayed across the fibre web by means of so-called atomized air-technique.

According to an alternative embodiment of the invention, the fibre web is corona-treated after the hydroentanglement step. This is done in order to increase the liquid absorption capacity of the nonwoven material, and in order to increase the wet strength of the material even further.

According to one embodiment of the invention, the hydroentanglement can be performed in two steps. In a first step, the fibre web is hydroentangled from one side. The hydroentanglement nozzles are arranged above the fibre web, and it is the top side in relation to the wire which is hydroentangled. In a second step, the fibre web is turned and hydroentangled from the other side.

In a way analogous to the hydroentanglement method, also the lint-preventing agent can be sprayed on in two steps: a first step in which the fibre web is sprayed from one side; and a second step in which the fibre web is turned and sprayed from the other side.

The invention also relates to a nonwoven material which has been treated with lint-preventing agent in accordance with the method. The nonwoven material is characterised in that at least a first external region contains more lint-preventing agent than an internal region. Thereby, “external region” primarily refers to the three-dimensional region which is constituted of one external surface of the fibre web and the region which is just below the surface. Accordingly, the fibre web exhibits a certain thickness, and it is across this thickness where the fibre web exhibits a gradient with regard to the concentration of lint-preventing agent.

### BRIEF DESCRIPTION OF THE DRAWING

FIG. 1 shows a sketch of a method of producing a nonwoven material according to one embodiment of the invention.

### DETAILED DESCRIPTION OF THE INVENTION

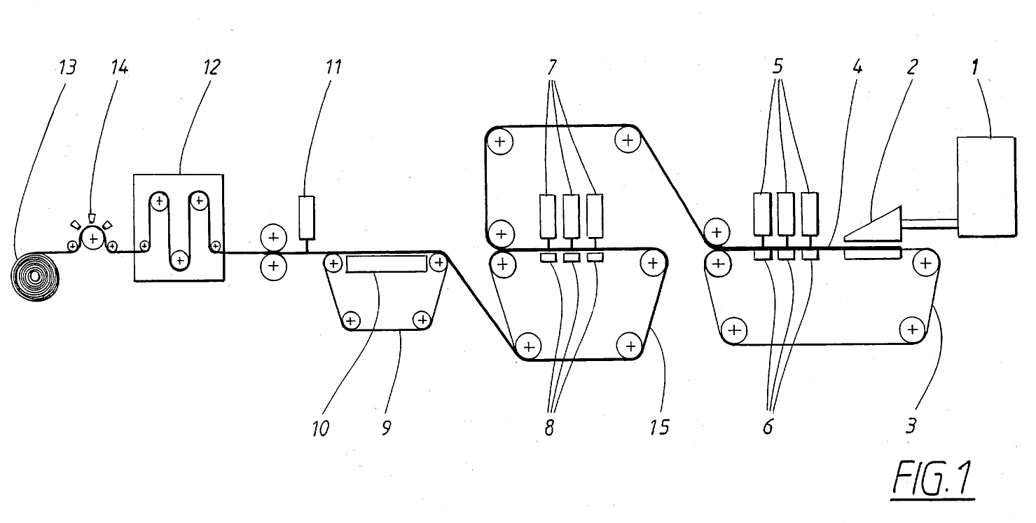

The following is a detailed description of a manufacturing method for nonwoven production including the process step which constitutes the invention. The production is described with reference to FIG. 1. Other steps which are described herein are by way of example only, and these can be carried out in alternative ways within the scope of the invention.

The nonwoven production process is initiated by shredding cellulose fibres from a bale of cellulose pulp and adding them to a water bath 1. Staple fibres of synthetic material are added to the water dispersion. As described above, there is an alternative to preformed synthetic fibres. The synthetic fibres are manufactured by means of extrusion as a part of the nonwoven production process. In that case, the cellulose fibres are wetformed onto the web of synthetic filaments which has been produced. Subsequently, the fibre dispersion is deposited onto a wire 3 by means of a headbox 2, wherein the fibres are dewatered through the wire.

Foam-forming is an alternative to the above-described wetforming of the fibre web. In foam-forming, a foam-forming surfactant is added to the fibre dispersion, whereafter the fibre dispersion is dewatered on a wire in corresponding way as in wetforming. One example of a method for foam-forming is disclosed in WO 96/02701.

Subsequently, the formed fibre web 4 is hydroentangled by means of one or several stations with hydroentanglement nozzles 5 located above the fibre web. Suction boxes 6 for collecting the hydroentanglement water are arranged below the hydroentanglement nozzles 5 and below the fibre web 4. The hydroentanglement water is recirculated, filtrated, and reused in the hydroentanglement. In the hydroentanglement, the fibre web is subjected to fine, high-pressure water jets. By means of the hydroentanglement, the fibres are entangled. This results in a stronger material in comparison to a nonwoven material which has not been hydroentangled. The hydroentanglement can be performed on both sides of the fibre web 4. The fibre web 4 will then be turned between two hydroentanglement stations. The second hydroentanglement station includes hydroentanglement nozzles 7 located above the fibre web 4, and suction boxes 8 located below the fibre web 4 and a wire 15.

The recirculation of the hydroentanglement water is performed by means of allowing the water to pass a number of cleaning steps. The first cleaning step is a flotation filter. The flotation filter operates by means of allowing high-pressure air to flow in at the bottom of cells containing the hydroentanglement water. By means of this method, air bubbles will be formed in the water, which air bubbles adhere to the fibres. The air bubbles and the fibres rise towards the surface of the flotation cells, where the fibres are scraped off by means of rotating scrapers. Normally, a sand filter is provided downstream the flotation filter. The sand filter operates as follows: the water from the flotation filter enters a filter bed of sand arranged in a sand filter cell through a pipe which discharges into the lower portion of the filter bed. The water rises through the filter bed, which moves downwards in the sand filter cell. In the upper portion of the cell, the filtrated water overflows and is passed further on to the next filter or back to the hydroentanglement station. By means of a pump, the used sand is passed upwards inside the cell to a space in the upper portion of the cell. Subsequently, the sand is allowed to fall down into a sand washing unit where it is rinsed in a counter current flow of a small filtrate quantity. The purified sand sinks back into its original position. The washing water is removed through a waste water outlet together with the solid particles which have accumulated in the filter. Downstream the sand filter, the hydroentanglement water is passed through a cartridge filter and is then returned to the hydroentanglement stations.

When the lint-preventing agent is added to the fibre dispersion in conventional process designs, the function of the flotation filter will be disturbed. Usually, the lint-preventing agent has a positive charge, and the fibres have a negative charge as a result of the carboxylic groups situated on the cellulose molecule. The lint-preventing agent will have a dispersing effect on the fine fibres in the dispersion. Consequently, the fibres will pass the flotation filter and will get trapped in and clog the subsequent filter, normally a sand filter. When this happens, the production has to be stopped and the filters have to be cleaned. This problem is solved by means of the invention. The sensitive equilibrium of charges in the fibre dispersion avoids the influence from the lint-preventing agent, when the agent is added subsequently to the hydroentanglement step.

The method according to the invention is not restricted to the above-described filter combination only. The described system is only an example of how a recirculation step may be designed.

After the second hydroentanglement, the fibre web 4 is dewatered further on a drainage wire 9 for which suction boxes 10 are provided. This step is optional and can be spared within the scope of the invention.

Spray nozzles 11 for the lint-preventing agent are arranged in a subsequent process step. The nozzles 11 are arranged above the fibre web 4 in its transversal direction. However, within the scope of the invention, it is conceivable to arrange the nozzles 11 in another way. Amongst other things, the required number of nozzles is dependent on the design of the individual nozzles, the speed of the fibre web and its width. Also the treatment with lint-preventing agent can be performed from two directions, in the same way as the hydroentanglement. The fibre web is turned between two successive spray nozzle stations.

In a subsequent step, the fibre web is dried in a through-air drier, a so-called TAD-dryer 12. In this step, the fibre web 4 is heated and possible cross-linking of chemicals can take place. After drying, the fibre web is wound onto a roll 13.

Within the scope of the invention, it is possible to subject the fibre web to after-treatment in a step subsequent to the drying step. Corona treatment is an example of such after-treatment. A set of apparatus for corona treatment is described in U.S. Pat. No. 4,283,291. The corona treatment improves the wettability and the wet strength of the nonwoven material. It is believed that the wettability is increased by the corona treatment since the corona treatment modifies the fibre surfaces and makes them more hydrophilic. It is assumed that the wet strength increases as a result of the treatment modifying the fibre surfaces in a way increasing the fibre-fibre friction. FIG. 1 shows a station for corona treatment 14.

### EXAMPLE

Fibre linting measurements were performed in accordance with the standard testing method IES-RP-CC004.2 (Institute of Environmental Sciences), “Evaluating materials used in clean rooms and other controlled environments”, “Chapter 5.2 “Biaxial shake linting”, with the following deviations from the standard method:

The test specimen size was reduced from 23×23 cm to 16×11 cm. The longer side of the test specimen was taken in the machine direction. No reference sample with water was done. The specimens were measured by means of measuring cylinders instead of utilising an automatic sampler. Since no clean room was available, all glass vessels were carefully rinsed with deionized water.

PAE (Kymene 617 from Hercules) was added to the fibre web by means of spray nozzles. In column 2, the targeted PAE-concentration is listed as a percentage of the dry weight of the fibre web. Subsequently, the actual concentration was analysed by means of hydrolysis in which adipic acid is produced and the amount was measured. This concentration is shown in column 3 in % of the dry weight of the fibre web. Trials without any pH-adjustment of the spraying liquid (PAE mixed with water) were performed. Trials 1-6 have been performed without any pH-adjustment. Trials with pH-adjustment where the pH was raised were also performed, something which increases the reaction rate for the cross-linking of PAE. Trials 7-12 have been performed with pH-adjustment of the spraying liquid. Fibre linting measurements were also performed on a reference sample. No PAE was sprayed on this sample.

As is evident from the table, the spraying of PAE on the fibre web has a striking effect on the fibre linting. The fibre Tinting after spraying is reduced with approx. 75% in comparison to the reference.

Results

| Trial | Add. PAE- | Meas. PAE- | Fibre linting |
|---|---|---|---|
| No. | quantity % | quantity % | particles/cm² |
| 1 | 0.6 | 0.49 | 98 |
| 2 | 0.3 | 0.37 | 77 |
| 3 | 0.15 | 0.15 | 82 |
| 4 | 0.06 | 0.07 | 200 |
| 5 | 0.03 | 0.03 | 156 |
| 6 | 0.015 | 0.02 | 217 |
| 7 | 0.54 | 0.4 | 80 |
| 8 | 0.27 | 0.38 | 110 |
| 9 | 0.135 | 0.15 | 139 |
| 10 | 0.054 | 0.09 | 92 |
| 11 | 0.027 | 0.04 | 122 |
| 12 | 0.014 | 0.023 | 191 |
| Reference | 0 | 0 | 380 |

1. A method of producing a nonwoven material including cellulose fibres and synthetic fibres, which comprises the steps of:
forming the fibres into a fibre web;
subjecting the fibre web to a hydroentanglement step; and
adding a lint-preventing agent to the fibre web through at least one spray nozzle in a step subsequent to the hydroentanglement.

2. The method of producing a nonwoven material according to claim 1, wherein the synthetic fibres are extruded into a web in one step, and the cellulose fibres are wetlaid onto this web in a step preceding the entanglement step.

3. The method of producing a nonwoven material according to claim 1, wherein the cellulose fibres and the synthetic fibres in the form of staple fibres are wetlaid in a step preceding the entanglement step.

4. The method of producing a nonwoven material according to claim 1, wherein the lint-preventing agent is mixed with water before it is sprayed across the fibre web.

5. The method of producing a nonwoven material according to claim 1, wherein the lint-preventing agent is mixed with air before it is sprayed across the fibre web.

6. The method of producing a nonwoven material according to claim 1, further comprising subjecting the fibre web to a corona treatment subsequently to the hydroentanglement step.

7. The method of producing a nonwoven material according to claim 1, wherein the hydroentanglement is performed in two steps: a first step in which the fibre web is hydroentangled from one side; and a second step in which the fibre web is turned and hydroentangled from the other side.

8. The method of producing a nonwoven material according to claim 1, wherein the lint-preventing agent is sprayed on in two steps: a first step in which the fibre web is sprayed from one side; and a second step in which the fibre web is turned and sprayed from the other side.

9. The method of producing a nonwoven material according to claim 1, wherein the lint-preventing agent is poly(amido-amine)-epichlorohydrin (PAE).

10. A nonwoven material in the form of a fibre web or fibre fabric including a lint-preventing agent, which fibre web or fibre fabric exhibits an internal region and a first and a second external region located on both sides of the internal region, and wherein at least the first external region contains more lint-preventing agent than the internal region.

11. The nonwoven material according to claim 10, wherein the lint-preventing agent is poly(amido-amine)-epichlorohydrin (PAE).
